(19) United States
(12) Patent Application Publication
(10) Pub. No.: US 2020/0199909 A1
(43) Pub. Date: Jun. 25, 2020

(54) RESTRICTIVE ACCESS CONTAINER

(71) Applicant: Thomas Fridley, Castle Rock, WA (US)

(72) Inventor: Thomas Fridley, Castle Rock, WA (US)

(21) Appl. No.: 16/721,870

(22) Filed: Dec. 19, 2019

Related U.S. Application Data
(60) Provisional application No. 62/782,694, filed on Dec. 20, 2018.
(60) Provisional application No. 62/787,436, filed on Jan. 2, 2019.

(51) Int. Cl. E05B 43/00; A24F 15/00; B65D 43/16; G07C 9/00

(52) U.S. Cl. CPC E05B 43/005; A24F 15/005; G07C 2009/00246; G07C 9/00182; B65D 43/169

(57) ABSTRACT

Disclosed herein is a restrictive access container that may include a container body, at least one container lid, a lock, at least one actuator, and a timer. Further, the container body may include at least one container wall and a container interior space formed by the at least one container wall. Further, the at least one container wall may include at least one container opening. Further, the at least one container lid openably coupled with the at least one container opening. Further, the lock may include a catch and a latch. Further, the catch and the latch are detachably attachable. Further, the lock may be associated with at least one of a lock state and an unlock state. Further, the at least one actuator operationally coupled with the lock. Further, the timer communicatively coupled with the at least one actuator. Further, the timer may be electrically powered.

### RELATED APPLICATION(S)

Under provisions of 35 U.S.C. § 119, the Applicant(s) claim the benefit of U.S. provisional application No. 62/782,694, filed on Dec. 20, 2018, which is incorporated herein by reference.

Under provisions of 35 U.S.C. § 119, the Applicant(s) claim the benefit of U.S. provisional application No. 62/787,436, filed on Jan. 2, 2019, which is incorporated herein by reference.

### TECHNICAL FIELD

Generally, the present disclosure relates to the field of packages and containers for goods. More specifically, the present disclosure relates to a restrictive access container.

### BACKGROUND

The field of packages and containers for goods is technologically important to several industries, business organizations and/or individuals. In particular, the use of containers is prevalent for storing objects in the containers. Further, the containers are used for retrieving the objects stored in the container.

Existing techniques for containers are deficient with regard to several aspects. For instance, current technologies do not restrict access to objects stored in the container during a particular time period. Furthermore, current technologies do not provide access to the objects stored in the container for during a particular time period.

Therefore, there is a need for a restrictive access container that may overcome one or more of the above-mentioned problems and/or limitations.

### BRIEF SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a restrictive access container that may include a container body, at least one container lid, a lock, at least one actuator, and a timer. Further, the container body may include at least one container wall and a container interior space formed by the at least one container wall. Further, the at least one container wall may include at least one container opening. Further, the at least one container lid openably coupled with the at least one container opening using at least one coupling mechanism. Further, the at least one container lid may be associated with at least one of an open state and a closed state in relation to the at least one container opening. Further, the at least one container lid may be configured to transition between the open state and the closed state. Further, the lock may include a catch and a latch. Further, each of the catch and the latch may be disposed on at least one of the container body and the at least one container lid. Further, the catch and the latch are detachably attachable. Further, the lock may be associated with at least one of a lock state and an unlock state. Further, the latch and the catch are attached in the lock state and the latch and the catch are detached in the unlock state. Further, the lock does not allow the at least one container lid to transition between the closed state and the open state in the lock state. Further, the lock allows the at least one container lid to transition between the closed state and the open state in the unlock state. Further, the at least one actuator operationally coupled with the lock. Further, the at least one actuator may be configured for performing at least one actuator operation. Further, the at least one actuator operation may include transitioning the lock between the lock state and the unlock state based on a timer signal. Further, the timer communicatively coupled with the at least one actuator. Further, the timer may be electrically powered. Further, the timer may be associated with a plurality of timer states. Further, the timer in a first timer state may be configured for transitioning to a second timer state after an elapse of at least one predetermined time period. Further, the timer may be configured for generating the timer signal based on the transitioning.

Further disclosed herein is a restrictive access container that may include a container body, at least one container lid, a lock, at least one actuator, a timer, a presentation device. Further, the container body may include at least one container wall and a container interior space formed by the at least one container wall. Further, the at least one container wall may include at least one container opening. Further, the at least one container lid openably coupled with the at least one container opening using at least one coupling mechanism. Further, the at least one container lid may be associated with at least one of an open state and a closed state in relation to the at least one container opening. Further, the at least one container lid may be configured to transition between the open state and the closed state. Further, the lock may include a catch and a latch. Further, each of the catch and the latch may be disposed on at least one of the container body and the at least one container lid. Further, the catch and the latch are detachably attachable. Further, the lock may be associated with at least one of a lock state and an unlock state. Further, the latch and the catch are attached in the lock state and the latch and the catch are detached in the unlock state. Further, the lock does not allow the at least one container lid to transition between the closed state and the open state in the lock state. Further, the lock allows the at least one container lid to transition between the closed state and the open state in the unlock state. Further, the at least one actuator operationally coupled with the lock. Further, the at least one actuator may be configured for performing at least one actuator operation. Further, the at least one actuator operation may include transitioning the lock between the lock state and the unlock state based on a timer signal. Further, the timer communicatively coupled with the at least one actuator. Further, the timer may be electrically powered. Further, the timer may be associated with a plurality of timer states. Further, the timer in a first timer state may be configured for transitioning to a second timer state after an elapse of at least one predetermined time period. Further, the timer may be configured for generating the timer signal based on the transitioning. Further, the presentation device communicatively coupled with the timer. Further, the presentation device may be configured for presenting a timer state of the plurality of timer states associated with the timer.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a perspective view of a restrictive access container, in accordance with some embodiments.

FIG. 3 is a perspective view of the restrictive access container with an open container lid, in accordance with some embodiments.

FIG. 4 is a front view of the restrictive access container with a closed container lid, in accordance with some embodiments.

FIG. 5 is the front view of the restrictive access container with an open container lid, in accordance with some embodiments.

FIG. 6 is a side view of the restrictive access container with a closed container lid, in accordance with some embodiments.

FIG. 7 is the side view of the restrictive access container with an open container lid, in accordance with some embodiments.

FIG. 8 is a rear view of the restrictive access container with a closed container lid, in accordance with some embodiments.

FIG. 9 is a perspective view of the restrictive access container for facilitating presenting of a timer state, in accordance with some embodiments.

FIG. 10 is a perspective view of the restrictive access container for facilitating storing of states of a container lid, in accordance with some embodiments.

FIG. 11 is a perspective view of the restrictive access container for facilitating the management of a lock based on a state of a user, in accordance with some embodiments.

FIG. 12 is a perspective view of the restrictive access container for facilitating the management of the lock, in accordance with some embodiments.

FIG. 13 is a perspective view of a restrictive access container, in accordance with some embodiments.

FIG. 14 is a block diagram of a computing device for implementing the methods disclosed herein, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of a restrictive access container, embodiments of the present disclosure are not limited to use only in this context.

Overview:

Further, the present disclosure describes a restrictive access container (a lockbox). The lockbox may include a lid with a hinge, and interior space which provides a snug fit for one pack of 20 cigarettes. The lid is locked, with an electric lock activated by a timer. When the lid is closed, the timer starts, enabling subsequent access to the contents after a specified time period selected by the user. The timer may be set by the user, using available control buttons. The lockbox is intended for use by tobacco users who are trying to gradually reduce their tobacco consumption.

Further, the lockbox includes a hinge and a battery compartment. The lockbox includes a lid, a timer, and control buttons. The lid is attached to the remaining body of the lockbox via the hinge. Further, the lockbox may be structurally and functionally identical to a conventional cigarette case, providing a storage compartment suitable for one standard pack of 20 cigarettes below the hinged lid. Further, the lockbox may be provided in various sizes to accommodate cigarette packs of various sizes, such as king-size and 100 millimeters, and is also provided in a variety of decorative colors and patterns. Further, the lid may be locked, with an electric lock activated by a timer. When the lid is closed, the timer starts, enabling subsequent access to the contents of the lockbox after a specified time period pre-selected by the user. The timer may be set by the user, using the control buttons. The timer is preferably powered by a rechargeable battery in a low profile battery compartment on the rear surface of the lockbox. Further, a user may enter a time period by using the control buttons. Further, the time period may correspond to a time gap that the user may want between smoking two cigarettes. When the timer expires, the lid may be opened. When the lid is closed, the timer restarts. Preferably, the lockbox, the lid, the control buttons, and the battery compartment are manufactured from rigid, durable materials such as steel, aluminum alloy, brass, ceramics, hardwood, and plastic. Further, the lockbox may include decorative elements. Preferably, the hinge and the timer are manufactured from a rigid, durable material with substantial structural strength, such as steel, aluminum alloy, or brass. Further, the lockbox is intended for use by tobacco users who are trying to gradually reduce their tobacco consumption. Further, the lockbox, with appropriate modifications or with no modifications at all, may be used in any context where one or more objects are stored in the lockbox, and the user desires access to such objects at predetermined intervals which are easily controlled and modified. The one or more objects may include cigars, a cigarette carton comprised of packs of cigarettes, or a child's favorite toy.

Further, the present disclosure describes the lockbox. Further, the lockbox provides a lid with a hinge and interior space which provides a snug fit for one pack of 20 cigarettes. The lid is locked, with an electric lock activated by a timer. When the lid is closed, the timer starts, enabling subsequent access to the contents after a specified time period selected by the user. The timer may be set by the user, using control buttons that are provided. The lockbox is intended for use by tobacco users who are trying to gradually reduce their tobacco consumption. Further, the lockbox may include at least one sensor to sense an environmental variable, physiological variable of the user and/or a state of the lockbox. Accordingly, the locking/unlocking may be performed automatically based on sensed parameter matching a predetermined criteria. Further, the lockbox may include a wired and/or a wireless communication interface to facilitate communication with an external device (e.g. smartphone). Accordingly, locking/unlocking may be based on data received from the external device which may in some cases include behavioral data. For example, a condition corresponding to increased likelihood of wanting to smoke or consume tobacco may be detected and accordingly the locking/unlocking may be controlled. Further, the lockbox may include a storage device to store all actions and timer values over a period of time and make it available for other users in the community and/or generating insights and recommendations. Accordingly timer values may be imported or exported to other users (i.e. crowd sourcing). Further, the lockbox may include a timer. Further, the timer may include a small battery. Further, the timer may be controlled to lock and unlock the lockbox. The smoker can set a time with the timer. Further, the lockbox stays locked and when the time runs out the smoker can get a cigarette and smoke. Further, the smoker then reset the time so the lockbox locks until his next set time. Further, the lockbox is small and can fit in a pocket or purse. Further, the point of the lockbox is to slow down smoking a little at a time.

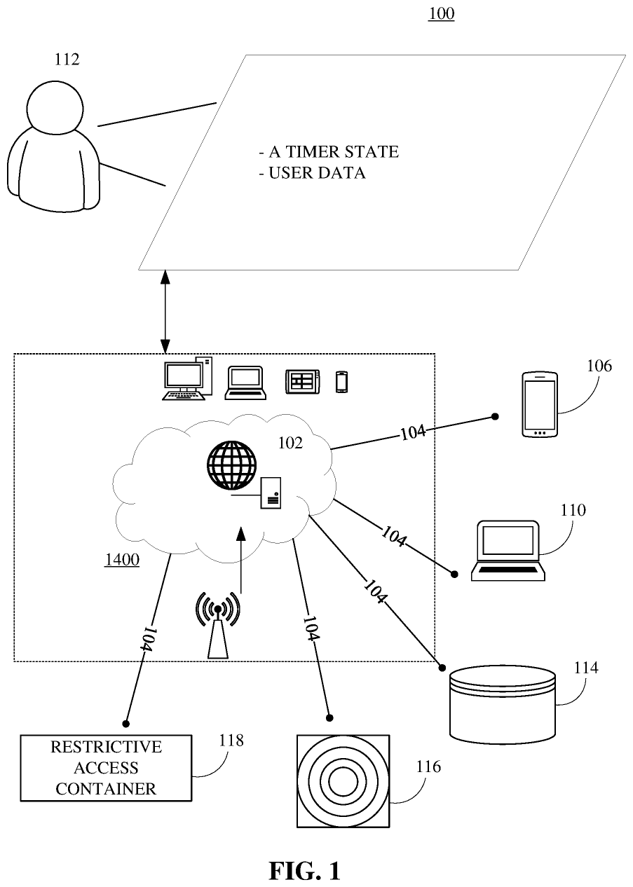

FIG. 1 is an illustration of an online platform 100 consistent with various embodiments of the present disclosure. By way of non-limiting example, the online platform 100 to facilitate the management of a restrictive access container may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, sensors 116, and a restrictive access container 118 over a communication network 104, such as but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web-based software application or browser. The web-based software application may be embodied as, for example, but not be limited to, a website, a web application, a desktop application, and a mobile application compatible with a computing device 1400.

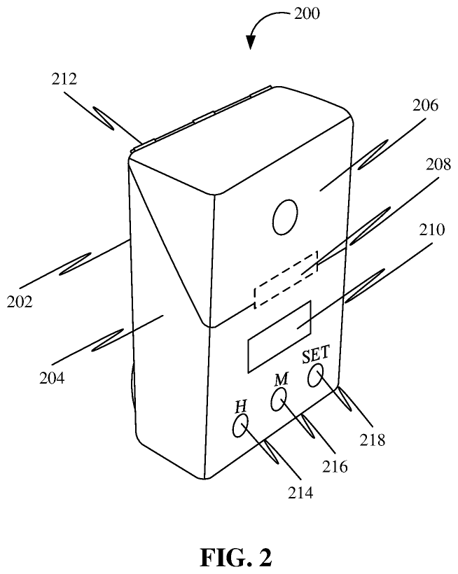

FIG. 2 is a perspective view of a restrictive access container 200, in accordance with some embodiments. Accordingly, the restrictive access container 200 may include a container body 202, at least one container lid 206, a lock 208, at least one actuator (not shown), and a timer 210.

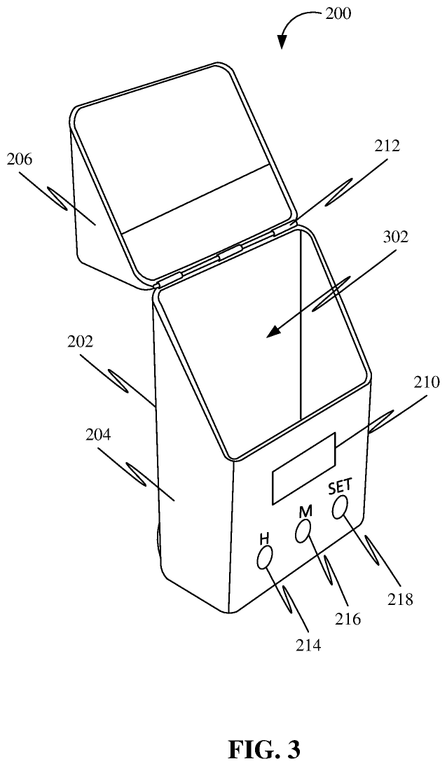

Further, the container body 202 may include at least one container wall 204 and a container interior space 302, as shown in FIG. 3, formed by the at least one container wall 204. Further, the at least one container wall 204 may include at least one container opening.

Further, the at least one container lid 206 openably coupled with the at least one container opening using at least one coupling mechanism 212. Further, the at least one coupling mechanism 212 may include a hinge, a slide, etc. Further, the at least one container lid 206 may be associated with at least one of an open state and a closed state in relation to the at least one container opening. Further, the at least one container lid 206 may be configured to transition between the open state and the closed state;

Further, the lock 208 may include a catch and a latch. Further, each of the catch and the latch may be disposed on at least one of the container body 202 and the at least one container lid 206. Further, the catch and the latch are detachably attachable. Further, the lock 208 may be associated with at least one of a lock state and an unlock state. Further, the latch and the catch are attached in the lock state and the latch and the catch are detached in the unlock state. Further, the lock 208 does not allow the at least one container lid 206 to transition between the closed state and the open state in the lock state. Further, the lock 208 allows the at least one container lid 206 to transition between the closed state and the open state in the unlock state.

Further, the at least one actuator operationally coupled with the lock 208. Further, the at least one actuator may be configured for performing at least one actuator operation. Further, the at least one actuator operation may include transitioning the lock 208 between the lock state and the unlock state based on a timer signal.

Further, the timer 210 communicatively coupled with the at least one actuator. Further, the timer 210 may be electrically powered. Further, the timer 210 may be associated with a plurality of timer states. Further, the timer 210 in a first timer state may be configured for transitioning to a second timer state after an elapse of at least one predetermined time period. Further, the timer 210 may be configured for generating the timer signal based on the transitioning.

Further, in some embodiments, the at least one container lid 206 may be configured to provide access to the container interior space 302 based on at least one of the closed state and the open state. Further, the at least one container lid 206 does not provide access to the container interior space 302 in the closed state. Further, the at least one container lid 206 provides access to the container interior space 302 in the open state.

Further, in some embodiments, at least one predetermined time period may include a first predetermined time period and a second predetermined time period. Further, the timer 210 in a first timer state may be configured for transitioning to a second timer state after an elapse of the first predetermined time period. Further, the timer 210 in the second timer state may be configured for transitioning to the first timer state after an elapse of the second predetermined time period.

In further embodiments, at least one input mechanism 214-216 communicatively coupled with the timer 210. Further, the input mechanism configured for generating at least one input data based on at least one input action performed by at least one user (such as the user 112) on the at least one input mechanism 214-216. Further, the at least one input data may include the at least one predetermined time period. Further, the input mechanism 214-216 may include a push-button, a switch, etc.

In further embodiments, at least one input button 218 communicatively coupled with the timer 210. Further, the at least one input button 218 may be disposed on the container body 202. Further, the at least one input button 218 may be configured for generating at least one button data based on the at least one button action performed by at least one user (such as the user 112) on the at least one input button 218. Further, the timer 210 in a first timer state may be configured for transitioning to a second timer state based on the at least one button data without an elapse of the at least one predetermined time period.

Further, in some embodiments, the at least one container wall 204 may include a main container wall and an extendable container wall. Further, the extendable container wall may be configured to transition through a plurality of container wall positions in relation to the main container wall. Further, the plurality of container wall positions may include a retracted position and at least one extended position. Further, the extendable container wall may be configured to transition between the retracted position and the at least one extended position. Further, in an embodiment, the at least one actuator may be operationally coupled with the at least one container wall 204. Further, the at least one actuator operation may include transitioning the extendable container wall between the retracted position and the at least one extended position.

Further, in some embodiments, the timer 210 may be operationally coupled with the at least one container lid 206. Further, a transition of the at least one container lid 206 from an open state to a closed state corresponds to a transition of the timer 210 from a first timer state to a second timer state.

Further, in some embodiments, the at least one actuator may be operationally coupled with the at least one container lid 206. Further, the at least one actuator transitions the at least one container lid 206 between the open state and the closed state in the unlock state. Further, the at least one actuator does not transition the at least one container lid 206 between the open state and the closed state in the lock state.

Further, in some embodiments, the restrictive access container 200 may include at least one power source. Further, the at least one power source may be electrically coupled with the timer 210 and the at least one actuator. Further, the at least one power source may be disposed on the container body 202. Further, the at least one power source may include a DC power source and an AC power source. Further, the DC power source may include a DC battery, a DC rechargeable battery, etc.

FIG. 3 is a perspective view of the restrictive access container 200 with an open container lid, in accordance with some embodiments.

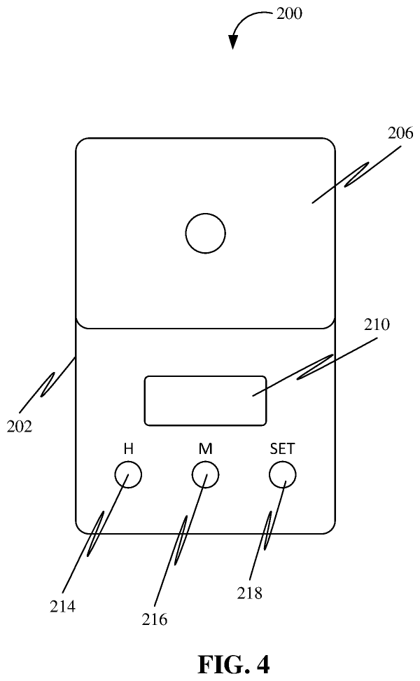

FIG. 4 is a front view of the restrictive access container 200 with a closed container lid, in accordance with some embodiments.

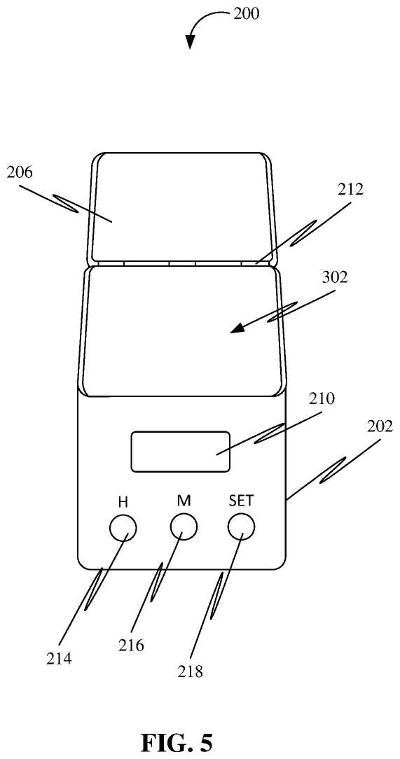

FIG. 5 is the front view of the restrictive access container 200 with an open container lid, in accordance with some embodiments.

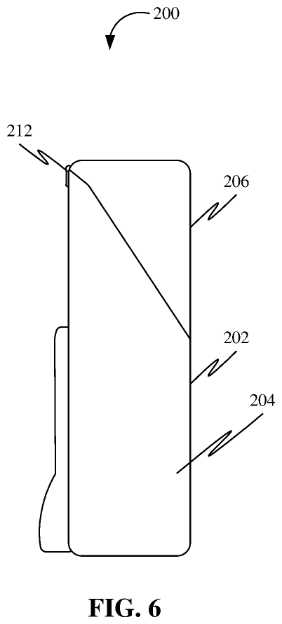

FIG. 6 is a side view of the restrictive access container 200 with a closed container lid, in accordance with some embodiments.

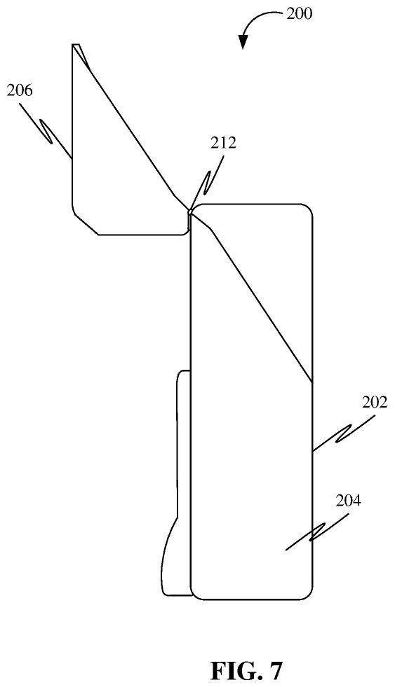

FIG. 7 is the side view of the restrictive access container 200 with an open container lid, in accordance with some embodiments.

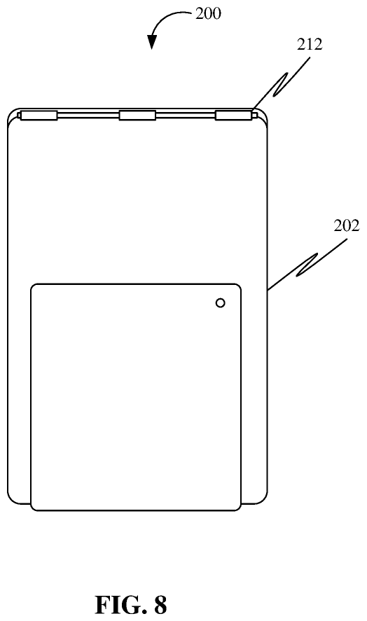

FIG. 8 is a rear view of the restrictive access container 200 with a closed container lid, in accordance with some embodiments.

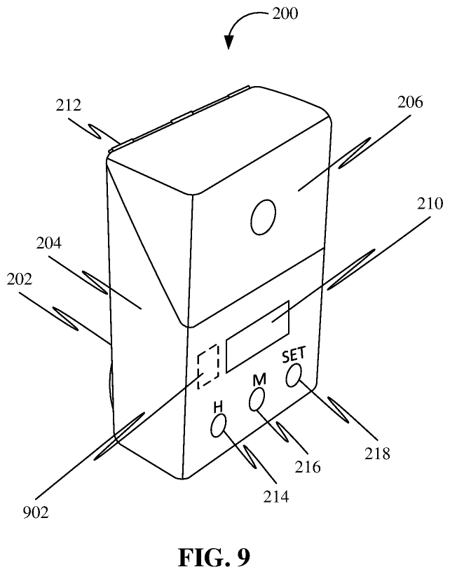

FIG. 9 is a perspective view of the restrictive access container 200 for facilitating presenting of a timer state, in accordance with some embodiments. Further, the restrictive access container 200 may include the container body 202, the at least one container lid 206, the lock 208, the at least one actuator, the timer 210, and a presentation device 902 (such as the mobile device 106 and the electronic devices 110).

Further, the presentation device 902 may be communicatively coupled with the timer 210. Further, the presentation device 902 may be configured for presenting a timer state of the plurality of timer states associated with the timer 210. Further, the presentation device 902 may be configured for presenting the timer state to at least one user (such as the user 112).

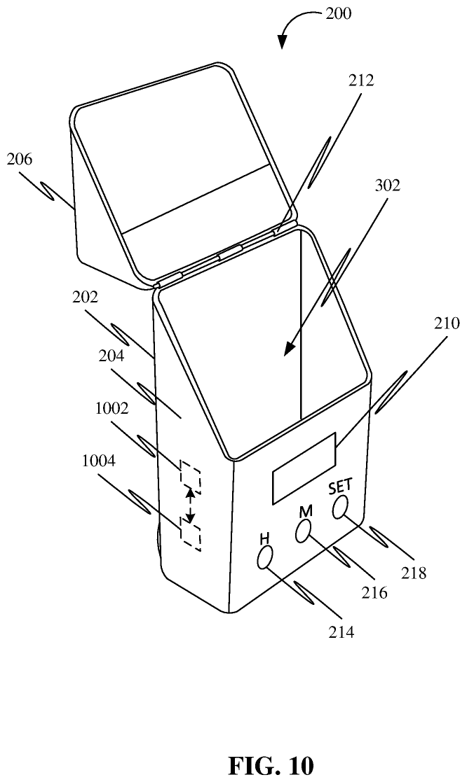

FIG. 10 is a perspective view of the restrictive access container 200 for facilitating storing of states of a container lid, in accordance with some embodiments. Further, the restrictive access container 200 may include the container body 202, the at least one container lid 206, the lock 208, the at least one actuator, the timer 210, at least one state sensor 1002 (such as the sensors 116), and a storage device 1004.

Further, the at least one state sensor 1002 disposed on the container body 202. Further, the at least one state sensor 1002 may be configured for generating at least one state sensor data based on at least one state of the at least one container lid 206. Further, the at least one state may be associated with at least one of the open state and the closed state of the at least one container lid 206.

Further, the storage device 1004 communicatively coupled with the at least one state sensor 1002. Further, the storage device 1004 may be configured for storing the at least one state sensor data. Further, the storage device 1004 may be configured for storing the at least one sate sensor data in a database (such as the databases 114).

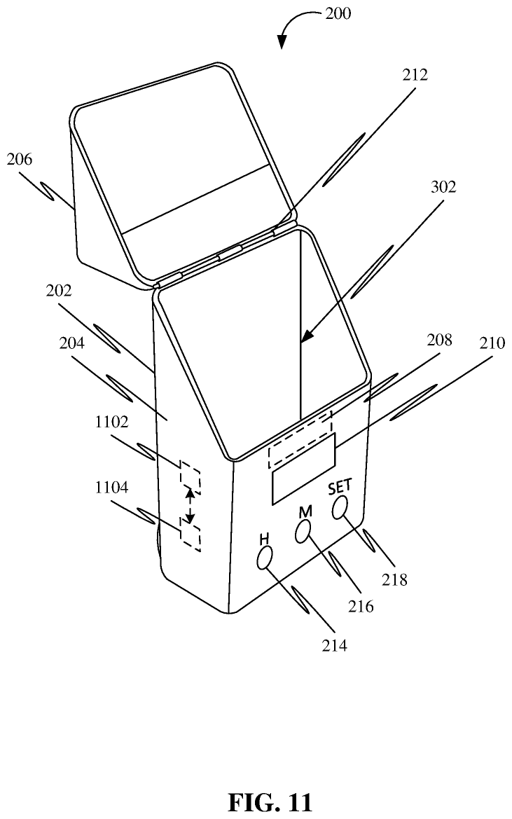

FIG. 11 is a perspective view of the restrictive access container 200 for facilitating the management of a lock 208 based on a state of a user, in accordance with some embodiments. Further, the restrictive access container 200 may include the container body 202, the at least one container lid 206, the lock 208, the at least one actuator, the timer 210, at least one sensor 1102 (such as the sensors 116), and a processing device 1104.

Further, the at least one sensor 1102 disposed on the container body 202. Further, the at least one sensor 1102 may be configured for generating at least one sensor data based on at least one state of the user (such as the user 112). Further, the user may be associated with the restrictive access container 200. Further, the at least state of the user may include a physical state, a physiological state, etc. Further, the physical state may be associated with vital signs such as, but not limited to, body temperature, blood pressure, respiration rate, pulse rate, etc. Further, the physiological state may include behavioral variables.

Further, the processing device 1104 may be communicatively coupled with the at least one sensor 1102. Further, the processing device 1104 may be configured for analyzing the at least one sensor data. Further, the processing device 1104 may be configured for generating control data based on the analyzing. Further, the at least one actuator may be communicatively coupled with the processing device 1104. Further, the at least one actuator may be configured for transitioning the lock 208 between the lock state and the unlock state based on the control data.

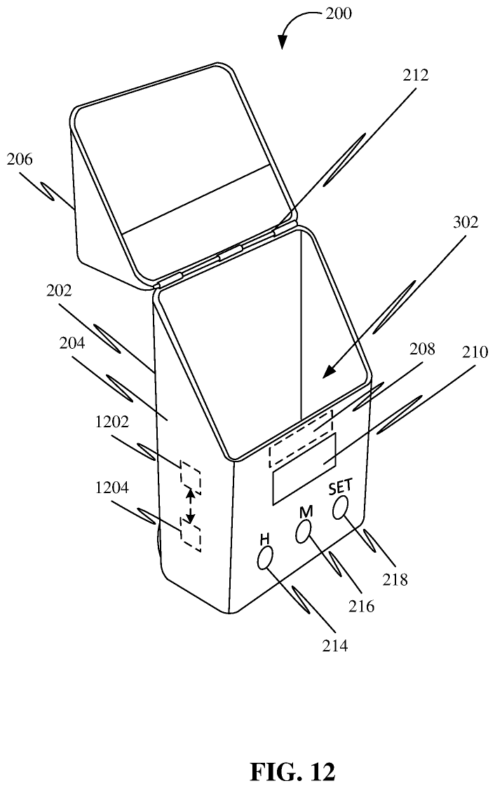

FIG. 12 is a perspective view of the restrictive access container 200 for facilitating the management of the lock 208, in accordance with some embodiments. Further, the restrictive access container 200 may include the container body 202, the at least one container lid 206, the lock 208, the at least one actuator, the timer 210, a communication device 1202, and a processing device 1204.

Further, the communication device 1202 disposed on the container body 202. Further, the communication device 1202 may be configured for receiving user data from at least one user device (such as the mobile device 106 and the electronic devices 110) over at least one of a wired communication channel and a wireless communication channel. Further, the at least one user device may be associated with at least one user (such as the user 112);

Further, the processing device 1204 communicatively coupled with the communication device 1202. Further, the processing device 1204 may be configured for analyzing the user data. Further, the processing device 1204 may be configured for generating user control data based on the analyzing. Further, the at least one actuator may be communicatively coupled with the processing device 1204. Further, the at least one actuator may be configured for transitioning the lock 208 between the lock state and the unlock state based on the user control data.

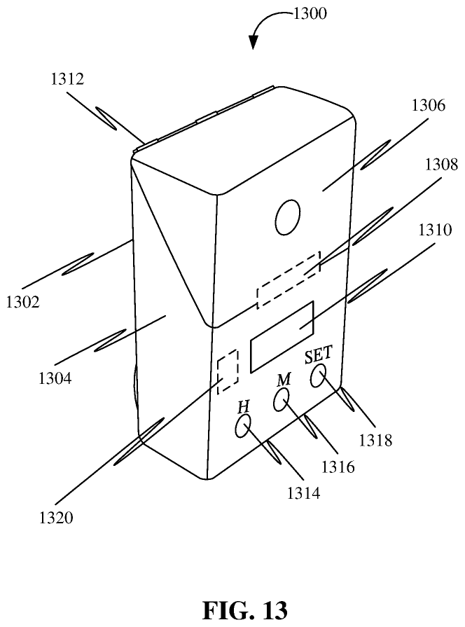

FIG. 13 is a perspective view of a restrictive access container 1300, in accordance with some embodiments. Accordingly, the restrictive access container 1300 may include a container body 1302, at least one container lid 1306, a lock 1308, at least one actuator (not shown), a timer 1310, and a presentation device 1320.

Further, the container body 1302 may include at least one container wall 1304 and a container interior space, formed by the at least one container wall 1304. Further, the at least one container wall 1304 may include at least one container opening.

Further, the at least one container lid 1306 openably coupled with the at least one container opening using at least one coupling mechanism 1312. Further, the at least one coupling mechanism 1312 may include a hinge, a slide, etc. Further, the at least one container lid 1306 may be associated with at least one of an open state and a closed state in relation to the at least one container opening. Further, the at least one container lid 1306 may be configured to transition between the open state and the closed state;

Further, the lock 1308 may include a catch and a latch. Further, each of the catch and the latch may be disposed on at least one of the container body 1302 and the at least one container lid 1306. Further, the catch and the latch are detachably attachable. Further, the lock 1308 may be associated with at least one of a lock state and an unlock state. Further, the latch and the catch are attached in the lock state and the latch and the catch are detached in the unlock state. Further, the lock 1308 does not allow the at least one container lid 1306 to transition between the closed state and the open state in the lock state. Further, the lock 1308 allows the at least one container lid 1306 to transition between the closed state and the open state in the unlock state.

Further, the at least one actuator operationally coupled with the lock 1308. Further, the at least one actuator may be configured for performing at least one actuator operation. Further, the at least one actuator operation may include transitioning the lock 1308 between the lock state and the unlock state based on a timer signal.

Further, the timer 1310 communicatively coupled with the at least one actuator. Further, the timer 1310 may be electrically powered. Further, the timer 1310 may be associated with a plurality of timer states. Further, the timer 1310 in a first timer state may be configured for transitioning to a second timer state after an elapse of at least one predetermined time period. Further, the timer 1310 may be configured for generating the timer signal based on the transitioning.

Further, the presentation device 1320 may be communicatively coupled with the timer 1310. Further, the presentation device 1320 may be configured for presenting a timer state of the plurality of timer states associated with the timer 1310. Further, the presentation device 1320 may be configured for presenting the timer state to at least one user (such as the user 112).

Further, in some embodiments, the restrictive access container 1300 may include at least one power source. Further, the at least one power source may be electrically coupled with the timer 1310 and the at least one actuator. Further, the at least one power source may be disposed on the container body 1302. Further, the at least one power source may include a DC power source and an AC power source. Further, the DC power source may include a DC battery, a DC rechargeable battery, etc.

Further, in some embodiments, the at least one container lid 1306 may be configured to provide access to the container interior space based on at least one of the closed state and the open state. Further, the at least one container lid 1306 does not provide access to the container interior space in the closed state. Further, the at least one container lid 1306 provides access to the container interior space in the open state.

Further, in some embodiments, at least one predetermined time period may include a first predetermined time period and a second predetermined time period. Further, the timer 1310 in a first timer state may be configured for transitioning to a second timer state after an elapse of the first predetermined time period. Further, the timer 1310 in the second timer state may be configured for transitioning to the first timer state after an elapse of the second predetermined time period.

In further embodiments, at least one input mechanism 1314-1316 communicatively coupled with the timer 1310. Further, the input mechanism configured for generating at least one input data based on at least one input action performed by at least one user (such as the user 112) on the at least one input mechanism 1314-1316. Further, the at least one input data may include the at least one predetermined time period. Further, the input mechanism 1314-1316 may include a push button, a switch, etc.

In further embodiments, at least one input button 1318 communicatively coupled with the timer 1310. Further, the at least one input button 1318 may be disposed on the container body 1302. Further, the at least one input button 1318 may be configured for generating at least one button data based on the at least one button action performed by at least one user (such as the user 112) on the at least one input button 1318. Further, the timer 1310 in a first timer state may be configured for transitioning to a second timer state based on the at least one button data without an elapse of the at least one predetermined time period.

Further, in some embodiments, the timer 1310 may be operationally coupled with the at least one container lid 1306. Further, a transition of the at least one container lid 1306 from an open state to a closed state corresponds to a transition of the timer 1310 from a first timer state to a second timer state.

Further, in some embodiments, the at least one actuator may be operationally coupled with the at least one container lid 1306. Further, the at least one actuator transitions the at least one container lid 1306 between the open state and the closed state in the unlock state. Further, the at least one actuator does not transition the at least one container lid 1306 between the open state and the closed state in the lock state.

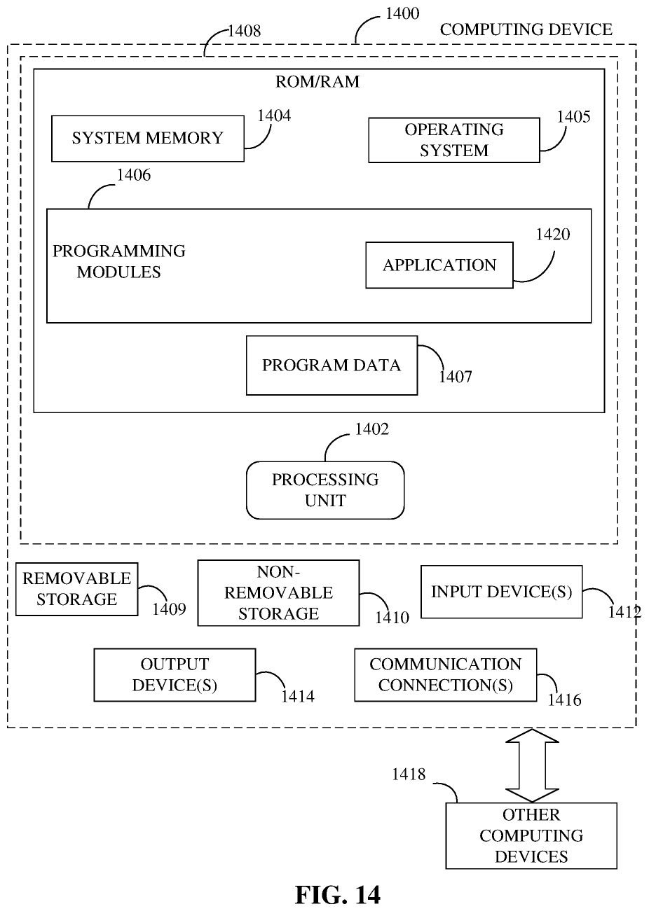

With reference to FIG. 14, a system consistent with an embodiment of the disclosure may include a computing device or cloud service, such as computing device 1400. In a basic configuration, computing device 1400 may include at least one processing unit 1402 and a system memory 1404. Depending on the configuration and type of computing device, system memory 1404 may comprise, but is not limited to, volatile (e.g. random-access memory (RAM)), non-volatile (e.g. read-only memory (ROM)), flash memory, or any combination. System memory 1404 may include operating system 1405, one or more programming modules 1406, and may include a program data 1407. Operating system 1405, for example, may be suitable for controlling computing device 1400′s operation. In one embodiment, programming modules 1406 may include the image-processing module, machine learning module. Furthermore, embodiments of the disclosure may be practiced in conjunction with a graphics library, other operating systems, or any other application program and is not limited to any particular application or system. This basic configuration is illustrated in FIG. 14 by those components within a dashed line 1408.

Computing device 1400 may have additional features or functionality. For example, computing device 1400 may also include additional data storage devices (removable and/or non-removable) such as, for example, magnetic disks, optical disks, or tape. Such additional storage is illustrated in FIG. 14 by a removable storage 1409 and a non-removable storage 1410. Computer storage media may include volatile and non-volatile, removable and non-removable media implemented in any method or technology for storage of information, such as computer-readable instructions, data structures, program modules, or other data. System memory 1404, removable storage 1409, and non-removable storage 1410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1400. Any such computer storage media may be part of device 1400. Computing device 1400 may also have input device(s) 1412 such as a keyboard, a mouse, a pen, a sound input device, a touch input device, a location sensor, a camera, a biometric sensor, etc. Output device(s) 1414 such as a display, speakers, a printer, etc. may also be included. The aforementioned devices are examples and others may be used.

Computing device 1400 may also contain a communication connection 1416 that may allow device 1400 to communicate with other computing devices 1418, such as over a network in a distributed computing environment, for example, an intranet or the Internet. Communication connection 1416 is one example of communication media. Communication media may typically be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer-readable media as used herein may include both storage media and communication media.

As stated above, a number of program modules and data files may be stored in system memory 1404, including operating system 1405. While executing on processing unit 1402, programming modules 1406 (e.g., application 1420 such as a media player) may perform processes including, for example, one or more stages of methods, algorithms, systems, applications, servers, databases as described above. The aforementioned process is an example, and processing unit 1402 may perform other processes.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general-purpose graphics processor-based systems, multiprocessor systems, microprocessor-based or programmable consumer electronics, application-specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid-state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

The following is claimed:

1. A restrictive access container comprising:
a container body comprises at least one container wall and a container interior space formed by the at least one container wall, wherein the at least one container wall comprises at least one container opening;
at least one container lid openably coupled with the at least one container opening using at least one coupling mechanism, wherein the at least one container lid is associated with at least one of an open state and a closed state in relation to the at least one container opening, wherein the at least one container lid is configured to transition between the open state and the closed state;
a lock comprises a catch and a latch, wherein each of the catch and the latch is disposed on at least one of the container body and the at least one container lid, wherein the catch and the latch are detachably attachable, wherein the lock is associated with at least one of a lock state and an unlock state, wherein the latch and the catch are attached in the lock state and the latch and the catch are detached in the unlock state, wherein the lock does not allow the at least one container lid to transition between the closed state and the open state in the lock state, wherein the lock allows the at least one container lid to transition between the closed state and the open state in the unlock state;
at least one actuator operationally coupled with the lock, wherein the at least one actuator is configured for performing at least one actuator operation, wherein the at least one actuator operation comprises transitioning the lock between the lock state and the unlock state based on a timer signal; and
a timer communicatively coupled with the at least one actuator, wherein the timer is electrically powered, wherein the timer is associated with a plurality of timer states, wherein the timer in a first timer state is configured for transitioning to a second timer state after an elapse of at least one predetermined time period, wherein the timer is configured for generating the timer signal based on the transitioning.

2. The restrictive access container of claim 1, wherein the at least one container lid is configured to provide access to the container interior space based on at least one of the closed state and the open state, wherein the at least one container lid does not provide access to the container interior space in the closed state, wherein the at least one container lid provides access to the container interior space in the open state.

3. The restrictive access container of claim 1 further comprising a presentation device communicatively coupled with the timer, wherein the presentation device is configured for presenting a timer state of the plurality of timer states associated with the timer.

4. The restrictive access container of claim 1, wherein at least one predetermined time period comprises a first predetermined time period and a second predetermined time period, wherein the timer in a first timer state is configured for transitioning to a second timer state after an elapse of the first predetermined time period, wherein the timer in the second timer state is configured for transitioning to the first timer state after an elapse of the second predetermined time period.

5. The restrictive access container of claim 1 further comprising at least one input mechanism communicatively coupled with the timer, wherein the input mechanism configured for generating at least one input data based on at least one input action performed by at least one user on the at least one input mechanism, wherein the at least one input data comprises the at least one predetermined time period.

6. The restrictive access container of claim 1 further comprising at least one input button communicatively coupled with the timer, wherein the at least one input button is configured for generating at least one button data based on the at least one button action performed by at least one user on the at least one input button, wherein the timer in a first timer state is configured for transitioning to a second timer state based on the at least one button data without an elapse of the at least one predetermined time period.

7. The restrictive access container of claim 1, wherein the at least one container wall comprises a main container wall and an extendable container wall, wherein the extendable container wall is configured to transition through a plurality of container wall positions in relation to the main container wall, wherein the plurality of container wall positions comprises a retracted position and at least one extended position, wherein the extendable container wall is configured to transition between the retracted position and the at least one extended position.

8. The restrictive access container of claim 7, wherein the at least one actuator is operationally coupled with the at least one container wall, wherein the at least one actuator operation comprises transitioning the extendable container wall between the retracted position and the at least one extended position.

9. The restrictive access container of claim 1, wherein the timer is operationally coupled with the at least one container lid, wherein a transition of the at least one container lid from an open state to a closed state corresponds to a transition of the timer from a first timer state to a second timer state.

10. The restrictive access container of claim 1, wherein the at least one actuator is operationally coupled with the at least one container lid, wherein the at least one actuator transitions the at least one container lid between the open state and the closed state in the unlock state, wherein the at least one actuator does not transition the at least one container lid between the open state and the closed state in the lock state.

11. The restrictive access container of claim 1 further comprising:
at least one state sensor disposed on the container body, wherein the at least one state sensor is configured for generating at least one state sensor data based on at least one state of the at least one container lid; and
a storage device communicatively coupled with the at least one state sensor, wherein the storage device is configured for storing the at least one state sensor data.

12. The restrictive access container of claim 1 further comprising:
at least one sensor disposed on the container body, wherein the at least one sensor is configured for generating at least one sensor data based on at least one state of a user, wherein the user is associated with the restrictive access container; and
a processing device communicatively coupled with the at least one sensor, wherein the processing device is configured for:
analyzing the at least one sensor data; and
generating control data based on the analyzing, wherein the at least one actuator is communicatively coupled with the processing device, wherein the at least one actuator is configured for transitioning the lock between the lock state and the unlock state based on the control data.

13. The restrictive access container of claim 1 further comprising:
a communication device disposed on the container body, wherein the communication device is configured for receiving user data from at least one user device over at least one of a wired communication channel and a wireless communication channel, wherein the at least one user device is associated with at least one user; and
a processing device communicatively coupled with the communication device, wherein the processing device is configured for:
analyzing the user data; and
generating user control data based on the analyzing, wherein the at least one actuator is communicatively coupled with the processing device, wherein the at least one actuator is configured for transitioning the lock between the lock state and the unlock state based on the user control data.

14. A restrictive access container comprising:
a container body comprises at least one container wall and a container interior space formed by the at least one container wall, wherein the at least one container wall comprises at least one container opening;
at least one container lid openably coupled with the at least one container opening using at least one coupling mechanism, wherein the at least one container lid is associated with at least one of an open state and a closed state in relation to the at least one container opening, wherein the at least one container lid is configured to transition between the open state and the closed state;
a lock comprises a catch and a latch, wherein each of the catch and the latch is disposed on at least one of the container body and the at least one container lid, wherein the catch and the latch are detachably attachable, wherein the lock is associated with at least one of a lock state and an unlock state, wherein the latch and the catch are attached in the lock state and the latch and the catch are detached in the unlock state, wherein the lock does not allow the at least one container lid to transition between the closed state and the open state in the lock state, wherein the lock allows the at least one container lid to transition between the closed state and the open state in the unlock state;
at least one actuator operationally coupled with the lock, wherein the at least one actuator is configured for performing at least one actuator operation, wherein the at least one actuator operation comprises transitioning the lock between the lock state and the unlock state based on a timer signal;
a timer communicatively coupled with the at least one actuator, wherein the timer is electrically powered, wherein the timer is associated with a plurality of timer states, wherein the timer in a first timer state is configured for transitioning to a second timer state after an elapse of at least one predetermined time period, wherein the timer is configured for generating the timer signal based on the transitioning; and
a presentation device communicatively coupled with the timer, wherein the presentation device is configured for presenting a timer state of the plurality of timer states associated with the timer.

15. The restrictive access container of claim 14, wherein the at least one container lid is configured to provide access to the container interior space based on at least one of the closed state and the open state, wherein the at least one container lid does not provide access to the container interior space in the closed state, wherein the at least one container lid provides access to the container interior space in the open state.

16. The restrictive access container of claim 14, wherein at least one predetermined time period comprises a first predetermined time period and a second predetermined time period, wherein the timer in a first timer state is configured for transitioning to a second timer state after an elapse of the first predetermined time period, wherein the timer in the second timer state is configured for transitioning to the first timer state after an elapse of the second predetermined time period.

17. The restrictive access container of claim 14 further comprising at least one input mechanism communicatively coupled with the timer, wherein the input mechanism configured for generating at least one input data based on at least one input action performed by at least one user on the at least one input mechanism, wherein the at least one input data comprises the at least one predetermined time period.

18. The restrictive access container of claim 14 further comprising at least one input button communicatively coupled with the timer, wherein the at least one input button is configured for generating at least one button data based on the at least one button action performed by at least one user on the at least one input button, wherein the timer in a first timer state is configured for transitioning to a second timer state based on the at least one button data without an elapse of the at least one predetermined time period.

19. The restrictive access container of claim 14, wherein the timer is operationally coupled with the at least one container lid, wherein a transition of the at least one container lid from an open state to a closed state corresponds to a transition of the timer from a first timer state to a second timer state.

20. The restrictive access container of claim 14, wherein the at least one actuator is operationally coupled with the at least one container lid, wherein the at least one actuator transitions the at least one container lid between the open state and the closed state in the unlock state, wherein the at least one actuator does not transition the at least one container lid between the open state and the closed state in the lock state.
